(19) United States
(12) Patent Application Publication
(10) Pub. No.: US 2018/0157237 A1
(43) Pub. Date: Jun. 7, 2018

(54) SERVO MOTOR CONTROLLER, SERVO MOTOR CONTROL METHOD, AND NON-TRANSITORY COMPUTER-READABLE MEDIUM STORING COMPUTER PROGRAM

(71) Applicant: FANUC CORPORATION, Yamanashi (JP)

(72) Inventors: Satoshi IKAI, Yamanashi (JP); Yuuki KUMAMOTO, Yamanashi (JP)

(21) Appl. No.: 15/829,035

(22) Filed: Dec. 1, 2017

(30) Foreign Application Priority Data
Dec. 2, 2016 (JP) 2016-235018

(51) Int. Cl. G05B 19/404

(52) U.S. Cl. CPC G05B 19/404

(57) ABSTRACT

A servo motor controller for performing more precise machining by calculating an appropriate compensation amount for a servo motor even in the case where the servo motor performs a reversal or the like. The controller includes a command calculation part for calculating a command for a position or a speed of a servo motor, a determining part for determining that the servo motor is performing “reversal” or “movement from stop,” an acceleration calculation part for obtaining the acceleration of the servo motor based on the determination result, and a compensation amount calculation part for calculating a compensation amount for compensation of delay of the servo motor. The acceleration calculation part obtains the acceleration even after the servo motor performs “reversal” or “movement from stop.” The compensation amount calculation part calculates the compensation amount according to the obtained acceleration, even after the servo motor performs “reversal” or “movement from stop.”

This application is based on and claims the benefit of priority from Japanese Patent Application No. 2016-235018, filed on 2 Dec. 2016, the content of which is incorporated herein by reference.

### BACKGROUND OF THE INVENTION

### Field of the Invention

The present invention relates to a servo motor controller for driving an axis of a machine tool. More particularly, the present invention relates to a servo motor controller, a servo motor control method, and a non-transitory computer-readable medium storing a computer program, which enables more appropriate calculation of an amount for compensation for a delay from a command for operation of a servo motor.

### Related Art

In a machine tool for driving an axis with a servo motor, the magnitude of friction varies at the time when a driving direction of the axis is reversed, that is, at the time when a rotational direction of the servo motor for driving the axis is reversed. That is, the magnitude of friction varies sequentially as “dynamic friction→static friction (larger than dynamic friction)→dynamic friction.” Thus, there is a problem that a delay occurs in a static friction region having large friction in the case of the servo motor (and its controller) always having the same responsiveness.

Similarly, when the axis is moved again from the stopped state after being stopped, the magnitude of friction varies as “static friction (larger than dynamic friction)→dynamic friction.” Thus, there is a problem that a delay occurs in a static friction region having large friction in the case of the servo motor and the like always having the same responsiveness. In a well-known technique for carrying out compensations in order to compensate for such delay, at the time of the reversal or at the start of movement from the stationary state, a prescribed compensation amount is calculated and added to a speed command given to the servo motor or to an integrator of a speed control loop. As the compensation amount herein, a fixed value set with a predetermined parameter, acceleration at the time of the reversal, acceleration immediately after the movement, and the like are used. Alternatively, other values are used such as a value obtained by multiplying the compensation amount by an override value corresponding to the square root of each of the accelerations.

A preferable value as the compensation amount can be determined by, for example, a circular waveform. Examples of such circular waveforms are shown in FIG. 3 and FIG. 4. Each of the circular waveforms is a diagram illustrating a control machining error in the case where a workpiece is subjected to machining along a circular locus. That is, each of the circular waveforms indicates a machining error in the case where arc-shaped machining is performed on a workpiece by circularly moving the workpiece side or the machining tool side by the use of two axes. In the description, it is assumed that the workpiece is fixed and the machining tool moves in an arc shape.

In FIG. 3 and FIG. 4, the machining tool, for example, is rotated in the rotational direction as shown in the figure in the manner that a first servo motor drives an X axis and a second servo motor drives a Y axis. Each of the solid lines in FIG. 3 and FIG. 4 indicates a position of the machining tool set according to a machining program of a workpiece, that is, a position command, while each of the broken lines indicates an actual position of the machining tool.

For example, in the third quadrant of FIG. 3, the first servo motor and the second servo motor respectively rotate to move the axes, so that the machining tool moves in the −(minus) X axis direction and in the +(plus) Y axis direction. When the machining tool moves from the third quadrant to the second quadrant, the second servo motor is similarly driven, while the first servo motor reverses so that the machining tool moves in the +(plus) X axis direction.

At this time, since the rotational direction of the first servo motor is reversed, the rotation stops instantaneously midway. Accordingly, the output axis of the first servo motor shifts from the dynamic friction state through the static friction state to the dynamic friction state again. When the rotation of the first servo motor is reversed as described above, the first servo motor goes through the static friction state where the frictional coefficient thereof is large, and is influenced by backlash in the transmission system of the first servo motor. Thus, a response delay occurs in the operation of the first servo motor. Such response delay at the time of the reversal appears in the measured value as a protrusion P, as shown in FIG. 3. Accordingly, in the case where a workpiece is subjected to machining along a circular arc, there arises a problem that a protrusion (corresponding to the protrusion P) remains on the workpiece at the machined position corresponding to the protrusion P, or other problems.

As described above, any one of the servo motors reverses on a circular waveform at four positions where quadrants are changed over. Thus, an error in the radial direction tends to become large. In an enlarged view, this error, which is observed as a protrusion in the radial direction, is referred to as a protrusion P. Accordingly, in the case where a circular waveform is used, a compensation amount is determined so that the protrusion P becomes smaller. This manner enables calculation of a preferable compensation amount. Since acceleration in a circular waveform is constant, the preferable compensation amount is a compensation amount suitable for performing an operation for the reversal at constant acceleration. As shown in FIG. 4, a protrusion can be substantially eliminated when a compensation amount obtained through adjustments as described above are applied.

For example, in Patent Document 1, in the case where a workpiece is subjected to machining along a circular arc, compensation processing is performed in such a manner that an integral element included in a speed control part is reversed based on a predetermined function at the time when a motor reverses, and the output value thereof is added to a current command value. Alternatively, in the case where the acceleration of a machining tool or the like is constant, a speed command given to a servo motor is also compensated in such a manner that a value obtained by multiplying a predetermined value by an override corresponding to the acceleration or the predetermined value itself is added to the speed command. Performing such compensation enables a reduction in the influence of backlash or the like at the time of the reversal, and thus failure in machining at a position corresponding to the protrusion P is expected to be reduced.

In addition, for example, Patent Document 2 discloses a technique for calculating a compensation amount using only one of either the acceleration before or after the reversal of the servo motor in the case where the acceleration varies between before and after the reversal.

Patent Document 1: PCT International Publication No. WO90/12448

Patent Document 2: Japanese Patent No. 4620148

### SUMMARY OF THE INVENTION

In the case of a machining program for machining a workpiece along a circular locus, it is preferable to perform machining by use of a compensation amount adjusted by the above-described method, and thereby a protrusion can be eliminated. However, in ordinary machining processing, a shape command is divided into commands for each axis, and then a prescribed time constant is applied to each axis at the time of execution of the operation. Therefore, in the case where the machining locus changes from a straight line to a circular arc, or where the machining locus changes from a circular arc to a straight line, the acceleration after the reversal in rotation of the servo motor may not be constant. Similarly, in the case where the machining locus changes from a straight line to a circular arc, or conversely changes from a circular arc to a straight line, the acceleration after the start of the moving operation in each axis may not be constant.

Moreover, in a machining program in which a machining locus is created by a set of minute line segments, the acceleration after the reversal in rotation of the servo motor is not constant in many cases. Similarly, in the machining program in which a machining locus is created by a set of minute line segments, the acceleration after the start of the moving operation in each axis from the stopped state is not constant in many cases. In such a case, conventionally, a compensation amount is adjusted on the premise that the acceleration is constant between before and after the reversal, or is constant after the start of the moving operation, and the adjusted compensation amount is applied as is. In other words, on the premise that, although the acceleration varies at the time of the reversal, the acceleration is constant after the reversal or the acceleration before the reversal is also constant, only one of the accelerations is used to calculate a compensation amount. When such a method is applied, the following problem arises.

That is, under the condition where the acceleration varies greatly, the acceleration may vary even after the reversal, and the acceleration may vary even midway to the reversal. For that reason, the compensation amount which is originally required (originally appropriate) at each point in time varies from moment to moment (not only at the time of the reversal). Therefore, there is a problem that the compensation amount sometimes becomes excessive and thereby a machining surface may be scratched, or the compensation amount becomes insufficient at other times and thereby a raised portion may remain on the surface of a workpiece due to insufficient machining.

The present invention has been made in view of such problems. The object of the present invention is to provide a servo motor controller capable of performing more precise processing by calculating an appropriate compensation amount for a servo motor even in the case where the servo motor performs a reversal or the like and the acceleration thereof varies after the reversal.

To achieve the above object, the present invention provides a servo motor controller for monitoring the acceleration thereof and changing a compensation amount according to the acceleration, even after the servo motor reverses in rotation or after the servo motor moves from a stopped state. A more specific description is given below.

(1) A servo motor controller (for example, a servo motor controller 100, which is described below) of the present invention is a servo motor controller for controlling a servo motor (for example, a servo motor 200, which is described below). The servo motor controller includes a command calculation part (for example, a speed command calculation part 102 or a position command calculation part 102b, which is described below) for calculating a command for a position or a speed of the servo motor at a predetermined cycle, a determining part (for example, a reversal detection part 104, which is described below) for determining that the servo motor is performing “reversal” or “movement from stop” at a predetermined cycle, an acceleration calculation part (for example, an acceleration calculation part 106, which is described below) for obtaining, when the determining part determines that the servo motor is performing “reversal” or “movement from stop,” the acceleration of the servo motor based on a result of the determination, and a compensation amount calculation part (for example, a compensation amount calculation part 108, which is described below) for calculating a compensation amount for compensation of delay of the servo motor when the servo motor performs “reversal” or “movement from stop.” The acceleration calculation part obtains the acceleration even after the servo motor performs “reversal” or “movement from stop.” The compensation amount calculation part calculates the compensation amount at every predetermined time according to the acceleration calculated by the acceleration calculation part, even after the servo motor performs “reversal” or “movement from stop.”

(2) In the servo motor controller according to (1), the compensation amount calculation part may calculate an overridden compensation amount by overriding the compensation amount.

(3) In the servo motor controller according to (2), when the determining part determines that the servo motor is performing “movement from stop,” the compensation amount calculation part may calculate the overridden compensation amount by multiplying the compensation amount by a coefficient smaller than 1.

(4) A servo motor control method of the present invention is a control method for controlling a servo motor. The control method includes the steps of calculating a command for a position or a speed of the servo motor at a predetermined cycle, determining that the servo motor is performing “reversal” or “movement from stop” at a predetermined cycle, calculating, when it is determined that the servo motor is performing “reversal” or “movement from stop” in the step of determining, the acceleration of the servo motor based on a result of the determination, and calculating a compensation amount for compensation of delay of the servo motor when the servo motor performs “reversal” or “movement from stop.” In the step of calculating the acceleration, the acceleration is calculated even after the servo motor performs “reversal” or “movement from stop.” In the step of calculating the compensation amount, the compensation amount is calculated at every predetermined time according to the acceleration obtained in the step of calculating the acceleration, even after the servo motor performs “reversal” or “movement from stop.”

(5) A non-transitory computer-readable medium storing the computer program according to the present invention is a non-transitory computer-readable medium storing a computer program for operating a computer as the servo motor controller according to (1). The computer is configured to execute the steps of calculating a command for a position or a speed of the servo motor at a predetermined cycle, determining that the servo motor is performing “reversal” or “movement from stop” at a predetermined cycle, calculating, when it is determined that the servo motor is performing “reversal” or “movement from stop” in the step of determining, the acceleration of the servo motor based on a result of the determination, and calculating a compensation amount for compensation of delay of the servo motor when the servo motor performs “reversal” or “movement from stop.” In the step of calculating the acceleration, the acceleration is calculated even after the servo motor performs “reversal” or “movement from stop.” In the step of calculating the compensation amount, the compensation amount is calculated at every predetermined time according to the acceleration obtained by the acceleration calculation part, even after the servo motor performs “reversal” or “movement from stop.”

The present invention enables more precise control of the servo motor because, even when the servo motor performs a reversal or the like, a more appropriate compensation amount is calculated and added to the command given to the servo motor.

### BRIEF DESCRIPTION OF THE DRAWINGS

FIG. 1 is a block diagram illustrating a configuration of a servo motor controller according to an embodiment of the present invention.

FIG. 2 is a graph illustrating the operation of the servo motor controller according to the embodiment of the present invention.

FIG. 3 is an explanatory diagram illustrating a circular waveform.

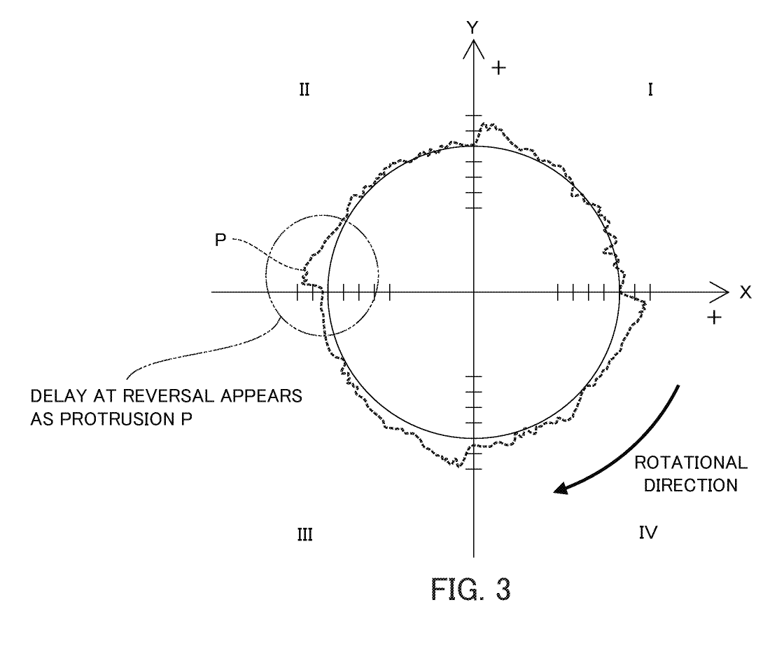

FIG. 4 is another explanatory diagram of the circular waveform.

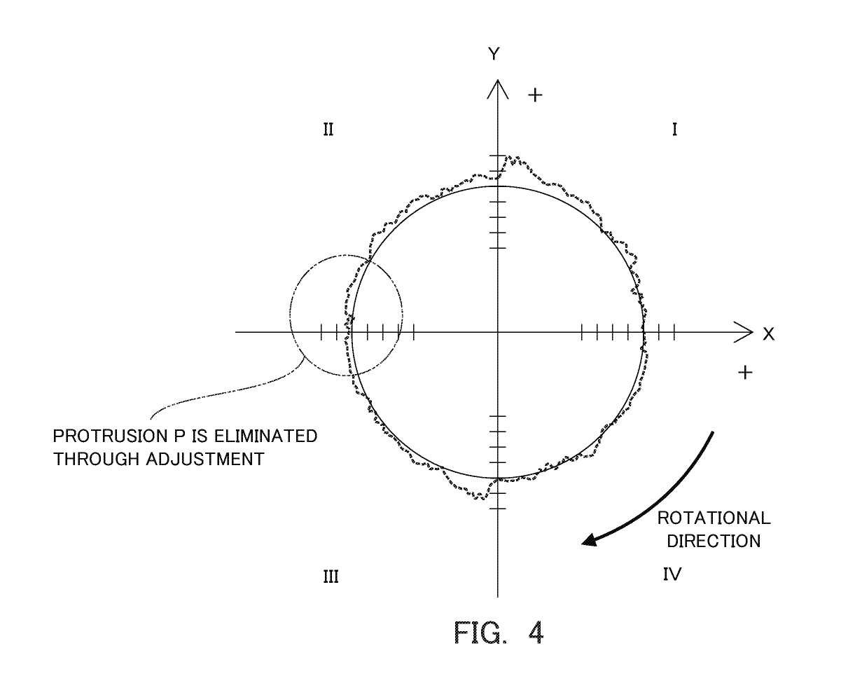

### DETAILED DESCRIPTION OF THE INVENTION

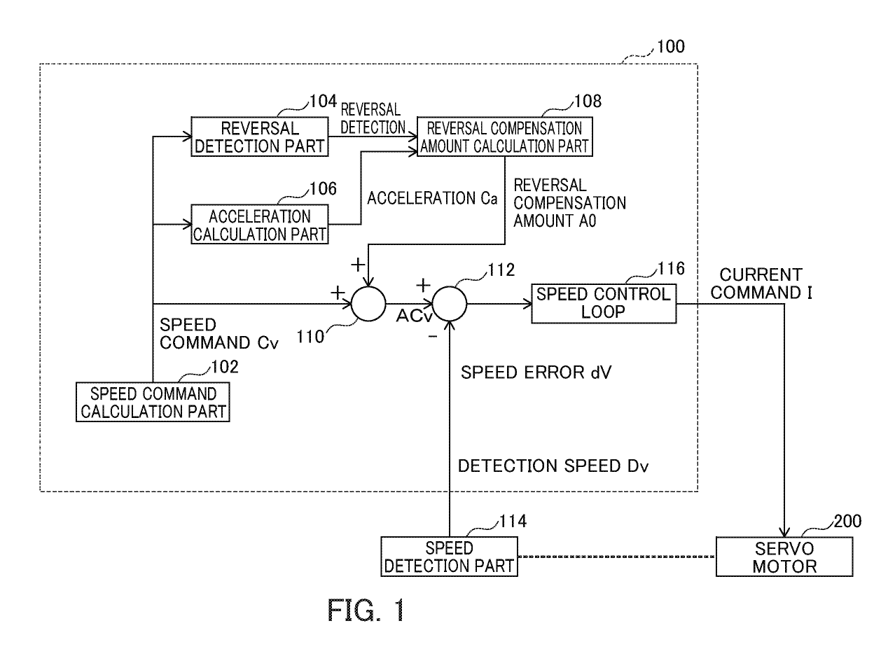

An example of an embodiment of the present invention is described below. In the present embodiment, a servo motor controller 100 for a machine tool is described. FIG. 1 shows a block diagram illustrating a configuration of the servo motor controller 100. The servo motor controller 100 calculates a speed command Cv given to a servo motor 200, and drives the servo motor 200 based on the speed command Cv, similar to a servo motor controller for a conventional machine tool. Accordingly, a servo motor controller used in a conventional machine tool can be easily replaced with the servo motor controller 100 of the present embodiment. In other words, the characteristic configuration in the present embodiment is the servo motor controller 100, and configurations other than the servo motor controller 100 are the same as those of a conventional machine tool.

As shown in FIG. 1, the servo motor controller 100 includes a speed command calculation part 102, a reversal detection part 104, an acceleration calculation part 106, a reversal compensation amount calculation part 108, a first adder 110, a second adder 112, and a speed control loop 116. A current command I output by the speed control loop 116 is supplied to the servo motor 200 to drive and control the servo motor. The servo motor 200 includes a speed detection part 114 for detecting the rotational speed of the servo motor 200, and the speed detection part 114 supplies to the servo motor controller 100 a detection speed Dv that has been detected.

It is noted that FIG. 1 shows only characteristic configurations in the present embodiment, the servo motor 200 to be controlled, and its relevant devices, without other general configurations or conventional configurations. Such operation and the like of general configurations and the like are known conventionally, and thus the explanation thereof is omitted. The servo motor controller 100 is preferably configured with various electronic circuits including a computer. Each part included in the servo motor controller 100 may be configured with hardware for realizing a function of each part, or with a program for realizing a function of each part and a CPU for executing the program. Each part may also be configured with hardware and a program for controlling the hardware.

The speed command calculation part 102 calculates a speed command Cv given to the servo motor 200. The speed command Cv, which is calculated based on a so-called machining program, may be calculated at a predetermined cycle. For example, the speed command calculation part 102 is capable of periodically calculating the speed command Cv given to the servo motor 200 to drive a machining tool for a workpiece, based on a machining program. In order to realize such processing, the speed command calculation part 102 is preferably configured with a program for reading a machining program and periodically obtaining a speed command Cv according to the program, and a CPU for executing the program. In the present embodiment, the speed command is described as a command, but other commands are applicable. For example, a position command may be used.

The reversal detection part 104 detects the reversal of the rotation of the servo motor 200 based on sign change of the speed command Cv calculated by the speed command calculation part 102. It is noted that the reversal detection part 104 may detect the reversal based on the actual detection speed Dv of the servo motor 200 obtained by the speed detection part 114 provided in the servo motor 200. The reversal detection part 104 may be configured with a program describing the operation thereof and a CPU for executing the program.

The acceleration calculation part 106 calculates an acceleration Ca of the servo motor 200 based on the speed command Cv calculated by the speed command calculation part 102. This calculation may be performed periodically as in the speed command calculation part 102. The acceleration Ca calculated by the acceleration calculation part 106 is supplied to the reversal compensation amount calculation part 108. The characteristic point in the present embodiment is to monitor the acceleration of the servo motor 200 even after the servo motor reverses, and obtain the compensation amount based on the acceleration. This allows for more precise control of the servo motor 200. The acceleration calculation part 106 calculates the acceleration Ca based on the speed command Cv calculated by the speed command calculation part 102 in the present embodiment. Alternatively, acceleration may be calculated based on the actually-detected detection speed Dv. The detection speed Dv is detected by the speed detection part 114 as described below. For example, the acceleration calculation part 106 may be configured with a program describing the operation for calculating acceleration by differentiating speed, and a CPU for executing the program.

The reversal compensation amount calculation part 108 calculates a reversal compensation amount A0 when the servo motor 200 reverses. This reversal compensation amount A0 is a compensation amount to be added to a command (for example, the speed command Cv) given to the servo motor 200, and is a compensation amount for compensation of delay of the servo motor 200. When the servo motor 200 reverses, a delay occurs in the rotation of the servo motor 200 due to backlash. In order to compensate such delay, the reversal compensation amount calculation part 108 calculates the reversal compensation amount A0 for the servo motor 200. As the reversal compensation amount A0, for example, a fixed value obtained based on various parameters or a value obtained by multiplying the fixed value by an override according to the acceleration of the servo motor 200 may be used. The reversal compensation amount calculation part 108 further calculates the reversal compensation amount A0 based on the acceleration calculated by the acceleration calculation part 106. The characteristic point in the present embodiment is that the reversal compensation amount calculation part 108 monitors (obtains) the acceleration even after the servo motor 200 reverses. The especially characteristic point in the present embodiment is the calculation of the reversal compensation amount A0 based on the acceleration which continues to be monitored (continues to be obtained). This allows for, even when the acceleration varies after the reversal, more appropriate calculation of the reversal compensation amount A0 based on the acceleration after the variation. As a result, the reversal compensation amount A0 can be calculated more precisely, as compared with the conventional method of calculating the compensation amount on the premise that the acceleration is constant between before and after the reversal. This allows for more precise control of the servo motor. For example, the reversal compensation amount calculation part 108 may be configured with a program describing the calculation operation thereof and a CPU for executing the program.

The first adder 110 adds the reversal compensation amount A0 calculated by the reversal compensation amount calculation part 108 to the speed command Cv to calculate a compensated speed command ACv. This allows for compensation of a response delay when the servo motor 200 reverses.

The speed detection part 114, which is provided in the servo motor 200, is a device for detecting the rotational speed of the servo motor 200. For example, the speed detection part 114 is preferably configured with an encoder or the like attached to the rotary axis of the servo motor 200. The speed detection part 114 detects the rotational speed of the servo motor 200, and supplies the detection speed Dv to the servo motor controller 100. In the case where the speed detection part 114 is configured with an encoder, a converter is preferably included to convert a signal output by the encoder into, for example, a digital signal. Alternatively, the encoder itself may output a digital signal indicating a rotational speed.

The second adder 112 obtains a final speed error dV by subtracting the detection speed Dv from the compensated speed command ACv obtained by the first adder 110. The obtained speed error dV is supplied to the speed control loop 116. The second adder 112 is an adder for performing feedback control for the servo motor 200 with respect to speed so as to rotate the servo motor 200 at a more accurate speed. For example, the first adder 110 or the second adder 112 may be configured with a digital adder (hardware) for adding a digital signal, or may be configured with a program for executing addition processing and a CPU for executing the program.

The speed control loop 116 calculates the current command I based on the speed error dV. Then, the speed control loop 116 drives and controls the servo motor 200 based on the current command I. Specifically, the speed control loop 116 calculates a speed control loop proportional term by multiplying the speed error dV by a speed control loop proportional gain. The speed control loop 116 further calculates a speed control loop integral term by multiplying the integral value of the speed error dV by a speed control loop integral gain. The current command I given to the servo motor 200 is calculated based on the sum of the speed control loop proportional term and the speed control loop integral term. The speed control loop 116 supplies current to the servo motor 200 based on the current command I, and drives the servo motor 200 at a rotational speed according to the speed command Cv. That is, the speed control loop 116 is typically configured with a program for calculating the current command I based on the speed error dV, and a CPU for executing the program. The speed control loop 116 further includes a power circuit (referred to as an amplifier circuit, a driver circuit, or the like) including a power control element for supplying current to the servo motor 200 based on the current command I.

The servo motor 200 is a servo motor conventionally used in a machine tool. The servo motor 200 is provided with the speed detection part 114, which is capable of detecting the speed of the servo motor 200.

The speed detection part 114 may be configured with any member capable of detecting the rotational speed of the servo motor 200. For example, a rotary encoder may be used. The rotational speed detected by the speed detection part 114, which is called a detection speed Dv, is supplied to the servo motor controller 100 for use in feedback control. Specifically, as shown in FIG. 1, the second adder 112 obtains the speed error dV by subtracting the detection speed Dv from the compensated speed command ACv. The speed control loop performs feedback control so as to reduce the speed error dV, thereby enabling to rotationally drive the servo motor 200 at a more precise speed.

Even in the case where the acceleration of the servo motor 200 varies after the servo motor 200 reverses, such a configuration enables calculation of the reversal compensation amount A0 according to the acceleration. Accordingly, the servo motor 200 can be controlled and driven more precisely.

The operation of the servo motor controller 100 according to the present embodiment is described below. In particular, the operation in the case of performing speed control for the servo motor 200 is described below. In the speed control, as shown in the configuration of FIG. 1, the speed error dV which is the difference between the speed command Cv and the detection speed Dv is input to the speed control loop 116. The speed control loop 116 calculates the current command I based on the speed error dV, and drives the servo motor 200 based on the current command I.

For example, as described above, the speed control loop 116 obtains the speed control loop proportional term by multiplying the speed error dV by the speed control loop proportional gain, and obtains the speed control loop integral term by multiplying the integral value of the speed error dV by the speed control loop integral gain. Then, the current command I is calculated based on the sum of both. Thereafter, in the present embodiment, the reversal detection part 104 determines that the servo motor 200 is performing “reversal” or “movement from stop.” When the reversal detection part 104 determines that the servo motor 200 is performing “reversal” or “movement from stop,” the reversal compensation amount calculation part 108 calculates the reversal compensation amount A0. The reversal compensation amount A0 is added to the speed command Cv, and thereby response delay of the servo motor 200 can be compensated.

In the present embodiment, the reversal compensation amount A0 is added to the speed command Cv. Alternatively, it is also preferable to add the reversal compensation amount A0 to the integral value of the speed error dV obtained by the speed control loop 116, which exerts similar effects. For example, in the case where the speed control loop 116 includes an integrating circuit for obtaining the integral value of the speed error dV, it is also preferable to insert an adder for adding the reversal compensation amount A0 to an output signal of the integrating circuit.

The servo motor controller 100 is preferably configured with an electronic circuit including a computer, as an example. The specific operation of the servo motor controller 100 configured with an electronic circuit including a computer is described below with reference to a flowchart.

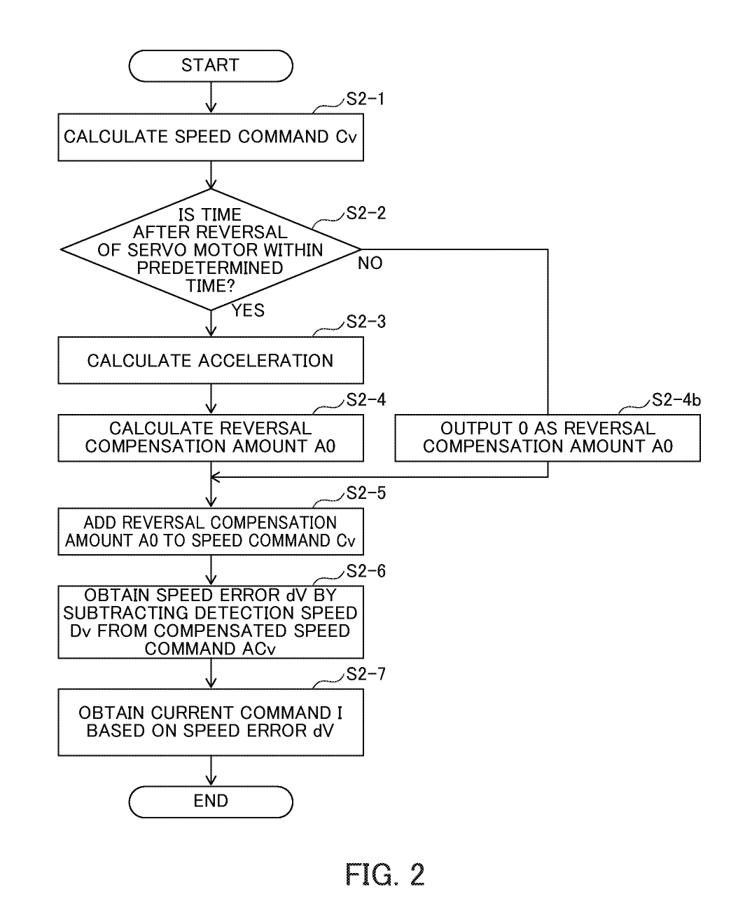

FIG. 2 shows a flowchart illustrating the operation of the servo motor controller 100. In Step S2-1, the speed command calculation part 102 calculates the speed command Cv given to the servo motor 200 at a predetermined cycle. Step S2-1 corresponds to a preferable example of a command calculation step according to the scope of the claims.

In Step S2-2, the reversal detection part 104 detects the reversal of the rotation of the servo motor 200 based on sign change of the speed command Cv calculated by the speed command calculation part 102. When the period of time after the reversal of the servo motor 200 is equal to or less than a predetermined period of time, the processing shifts to Step S2-3. In the case where the period of time after the reversal of the servo motor 200 exceeds a predetermined period of time, the processing shifts to Step S2-4b. The predetermined period of time herein is a period of time set in advance with parameters or the like. It is noted that the reversal may be detected based on the actual detection speed Dv of the servo motor 200 obtained by the speed detection part 114 (encoder) provided in the servo motor 200. Step S2-2 corresponds to a preferable example of a determining step according to the scope of the claims.

In Step S2-3, the acceleration calculation part 106 calculates the acceleration Ca of the servo motor at a predetermined cycle based on the speed command Cv calculated by the speed command calculation part 102. It is noted that the acceleration may be calculated based on the actually detected speed Dv. The characteristic point in the present embodiment is that the acceleration calculation in Step S2-3 continues to be performed even after the reversal. This allows for, even when machining processing is performed such that the acceleration varies after the reversal, calculation of a compensation amount according to the acceleration at the time. It is noted that the acceleration calculation in Step S2-3 may be configured to be performed after the detection of the reversal. Moreover, the acceleration calculation in Step S2-3 may be configured to be performed continuously from before the detection of the reversal (before the reversal). As shown in the flowchart of FIG. 2, the operation to be performed after the detection of the reversal is mainly described. Step S2-3 corresponds to a preferable example of an acceleration calculation step according to the scope of the claims.

In Step S2-4, the reversal compensation amount calculation part 108 calculates the reversal compensation amount A0 in the case where the servo motor 200 reverses. The reversal compensation amount A0 is calculated in the same manner as the above-described operation of the reversal compensation amount calculation part 108. The characteristic point in the present embodiment is that the acceleration calculation part 106 continues to calculate the acceleration after the servo motor 200 reverses, and in response, the reversal compensation amount calculation part 108 continues to calculate the reversal compensation amount A0 based on the calculated acceleration. This allows for, even when the acceleration varies after the reversal, more appropriate calculation of the reversal compensation amount A0 based on the acceleration after the variation. It is noted that Step S2-4 corresponds to a preferable example of a compensation amount calculation step according to the scope of the claims. On the other hand, in Step S2-4b, the reversal compensation amount calculation part 108 outputs 0 as the reversal compensation amount A0. The servo motor 200 is not reversed, and thus the compensation based on the reversal is not to be performed.

In Step S2-5, the first adder 110 obtains the compensated speed command AC0 by adding the compensation amount A0 to the speed command Cv. Therefore, in the case where the servo motor 200 reverses, the compensation is made. On the other hand, in the case where the servo motor 200 is not reversed, the first adder 110 adds 0 as the compensation amount, and thus no compensation is made substantially.

In Step S2-6, the second adder 112 obtains the so-called speed error dV by subtracting from the compensated speed command ACv the detection speed Dv which is the actual speed of the servo motor 200 detected by the speed detection part 114.

In Step S2-7, the speed control loop 116 obtains the current command I given to the servo motor 200 based on the above speed error dV. The speed control loop 116 further supplies predetermined current to the servo motor 200 based on the current command I, and controls and drives the servo motor. As described above, according to the present embodiment, in the case where the servo motor 200 reverses, the acceleration of the servo motor 200 is obtained, and the compensation amount to the speed command Cv is calculated based on the obtained acceleration. This allows for more precise control of the servo motor 200 even in the case where the acceleration varies after the servo motor 200 reverses. It is noted that a non-transitory computer-readable medium storing the various programs described in the present embodiment corresponds to a preferable example of a non-transitory computer-readable medium storing the computer programs according to the scope of the claims.

Although the embodiment of the present invention has been described in detail above, the above-described embodiment merely indicates a specific example for carrying out the present invention. The technical scope of the present invention is not limited to the above embodiment. The present invention may be modified in various ways without departing from the spirit thereof, and these modifications are also included in the technical scope of the present invention.

The case where the servo motor 200 performs “reversal” has been described mainly as an example. Alternatively, in the case where the servo motor 200 starts moving from a stopped state (referred to as “movement from stop”), the same processing as in the case of the reversal may be performed. In the above description, “reversal” can be replaced with “movement from stop” at any time. Also in the case of “movement from stop,” the servo motor 200 can be controlled more precisely as in the case described above. That is, the reversal detection part 104 may detect either “reversal” or “movement from stop” of the servo motor 200. The reversal detection part 104 may detect either one of them, or may detect both of them.

In the case where the reversal detection part 104 detects “reversal” or “movement from stop,” the reversal compensation amount calculation part 108 may calculate the reversal compensation amount A0 by the same processing as the above-described processing. In the case of “movement from stop,” the reversal compensation amount calculation part 108 preferably multiplies the acceleration of the servo motor 200 by an override which is smaller than 1. Also in the case where the reversal detection part 104 detects “movement from stop,” each of the acceleration calculation part 106, the first adder 110, the second adder 112, the speed detection part 114, and the speed control loop 116 performs the same operation as in the case of “reversal.”

In the example described above, the servo motor controller 100 has been described mainly with respect to speed control as an example. Alternatively, other control methods may be used. For example, in the case where position control, acceleration control or the like is performed, a compensation amount may be calculated by the same method so that the position or the like of a servo motor is controlled. For example, in the case of position control, a position command calculation part 102b may be used instead of the speed command calculation part 102. The position command calculation part 102b calculates a position command given to the servo motor 200 based on a machining program in the same manner as the speed command calculation part 102. The position command calculation part 102b may also be configured with a program for realizing the operation thereof and a CPU for executing the program, as in the speed command calculation part 102.

### EXPLANATION OF REFERENCE NUMERALS

100 SERVO MOTOR CONTROLLER
102 SPEED COMMAND CALCULATION PART
104 REVERSAL DETECTION PART
106 ACCELERATION CALCULATION PART
108 REVERSAL COMPENSATION AMOUNT CALCULATION PART
110 FIRST ADDER
112 SECOND ADDER
114 SPEED DETECTION PART
116 SPEED CONTROL LOOP
A0 REVERSAL COMPENSATION AMOUNT
ACv COMPENSATED SPEED COMMAND
Ca ACCELERATION
Cv SPEED COMMAND
Dv DETECTION SPEED
dV SPEED ERROR
I CURRENT COMMAND
P PROTRUSION

What is claimed is:

1. A servo motor controller for controlling a servo motor, the servo motor controller comprising:
a command calculation part for calculating a command for a position or a speed of the servo motor at a predetermined cycle;
a determining part for determining that the servo motor is performing “reversal” or “movement from stop” at a predetermined cycle;
an acceleration calculation part for obtaining, when the determining part determines that the servo motor is performing “reversal” or “movement from stop,” the acceleration of the servo motor based on a result of the determination; and
a compensation amount calculation part for calculating a compensation amount for compensation of delay of the servo motor when the servo motor performs “reversal” or “movement from stop,” wherein
the acceleration calculation part obtains the acceleration even after the servo motor performs “reversal” or “movement from stop,” and
the compensation amount calculation part calculates the compensation amount at every predetermined time according to the acceleration calculated by the acceleration calculation part, even after the servo motor performs “reversal” or “movement from stop.”

2. The servo motor controller according to claim 1, wherein
the compensation amount calculation part calculates an overridden compensation amount by overriding the compensation amount.

3. The servo motor controller according to claim 2, wherein
when the determining part determines that the servo motor is performing “movement from stop,” the compensation amount calculation part calculates the overridden compensation amount by multiplying the compensation amount by a coefficient smaller than 1.

4. A control method for controlling a servo motor, the control method comprising the steps of:
calculating a command for a position or a speed of the servo motor at a predetermined cycle;
determining that the servo motor is performing “reversal” or “movement from stop” at a predetermined cycle;
calculating, when it is determined that the servo motor is performing “reversal” or “movement from stop” in the step of determining, the acceleration of the servo motor based on a result of the determination; and
calculating a compensation amount for compensation of delay of the servo motor when the servo motor performs “reversal” or “movement from stop,” wherein
in the step of calculating the acceleration, the acceleration is continued to be calculated even after the servo motor performs “reversal” or “movement from stop,” and
in the step of calculating the compensation amount, the compensation amount is continued to be calculated at every predetermined time according to the acceleration obtained in the step of calculating the acceleration, even after the servo motor performs “reversal” or “movement from stop.”

5. A non-transitory computer-readable medium storing a computer program for operating a computer as the servo motor controller according to claim 1, the computer being configured to execute the steps of:
calculating a command for a position or a speed of the servo motor at a predetermined cycle;
determining that the servo motor is performing “reversal” or “movement from stop” at a predetermined cycle;
calculating, when it is determined that the servo motor is performing “reversal” or “movement from stop” in the step of determining, the acceleration of the servo motor based on a result of the determination; and
calculating a compensation amount for compensation of delay of the servo motor when the servo motor performs “reversal” or “movement from stop,” wherein
in the step of calculating the acceleration, the acceleration is calculated even after the servo motor performs “reversal” or “movement from stop,” and
in the step of calculating the compensation amount, the compensation amount is calculated at every predetermined time according to the acceleration obtained by the acceleration calculation part, even after the servo motor performs “reversal” or “movement from stop.”
